(19) United States
(12) Patent Application Publication
(10) Pub. No.: US 2014/0122104 A1
(43) Pub. Date: May 1, 2014

(54) COACHING SYSTEM THAT BUILDS COACHING MESSAGES FOR PHYSICAL ACTIVITY PROMOTION

(71) Applicant: KONINKLIJKE PHILIPS N.V., EINDHOVEN (NL)

(72) Inventors: AART TIJMEN VAN HALTEREN, GELDROP (NL); JOYCA PETRA WILMA LACROIX, EINDHOVEN (NL); GIJS GELEIJNSE, GELDROP (NL); MARTIN JEROEN PIJL, EINDHOVEN (NL); PRIVENDER KAUR SAINI, VELDHOVEN (NL); MAURITS CLEMENS KAPTEIN, NIJMEGEN (NL); JOSE LUIS GRACIA FERRON, AMSTERDAM (NL); ROGER HOLMES, AMSTERDAM (NL)

(73) Assignee: KONINKLIJKE PHILIPS N.V., EINDHOVEN (NL)

(21) Appl. No.: 14/056,152

(22) Filed: Oct. 17, 2013

Related U.S. Application Data
(60) Provisional application No. 61/756,130, filed on Jan. 24, 2013.
(60) Provisional application No. 61/718,904, filed on Oct. 26, 2012.

(51) Int. Cl. G06F 19/00

(52) U.S. Cl. CPC G06F 19/3418
USPC 705/2

(57) ABSTRACT

The invention concerns a system, method, apparatus, and computer readable medium for promoting a healthier life style of a subject. The method includes the steps of detecting a triggering event relating to a subject, reviewing a user profile associated with the subject which includes information relating to the subject, searching a text fragment database including a collection of text fragments and selecting appropriate text fragments based in part on the specific user profile of the particular subject, and sending the text fragments selected to a coach for forwarding to the subject, review, or amendment.

### CROSS-REFERENCE TO PRIOR APPLICATIONS

This application claims the benefit of U.S. Provisional Patent Applications Nos. 61/756,130 and 61/718,904, filed on Jan. 24, 2013 and Oct. 26, 2012. These applications are hereby incorporated by reference herein.

### FIELD OF THE INVENTION

The invention relates to the field of promoting a healthier lifestyle to a subject, and in particular to, for example, a system, a method, and a computer readable medium for promoting a healthier lifestyle of a subject.

### BACKGROUND OF THE INVENTION

A growing body of scientific studies shows that a person's risk of developing a chronic disease can be significantly reduced when that person adheres to a healthy lifestyle. A healthy lifestyle typically includes sufficient physical activity, a balanced diet, no smoking, and prevention of obesity. The insights into these modifiable risk-factors have led to a growing number of health promotion programs, and they have raised the awareness among consumers that managing one's health is important.

Programs that promote a healthy lifestyle appear in different forms, ranging from media campaigns, online web content, and doctor prescriptions to face-to-face sessions. These different forms have different costs and efficiencies.

One indicator for the efficacy of a program for promoting a healthy lifestyle is the degree to which a participant changes his/her lifestyle and adheres to the advice given. However, for many people, making deliberate lifestyle changes is often not so straightforward and maintaining a change in behavior over time is difficult. Programs for promoting a healthy lifestyle often offer some form of interactive coaching to guide consumers along their journey to a healthier lifestyle, create awareness, commitment to lifestyle goals, and provide support. Thus, the coaching entails the delivery of practical as well as empathic health behavior change support, considering the cognitive, emotional and behavioral aspects of behavior change. The domains covered by the coaching can include physical activity, physical exercises, intake of food, relaxation, weight management, smoking, and sleep.

Coaching a participant is about a purposeful interaction between a coach and the participant(s) being coached with the aim of achieving an agreed goal. At a national level, internet-based interventions are more cost-effective than visits to a general practitioner or a physiologist. Further, coaching consumers may involve providing insight into their own behavior and personal barriers, creating a perspective and translating this perspective into suitable goals, guiding the consumer by delivering personalized, actionable advice, providing reward and satisfaction with achievements, and providing support in dealing with difficult situations. Moreover, personalization and timing are highly relevant aspects for an effective realization of these coaching elements. Without the proper level of personalization and timing, coaching will quickly become inefficient, annoying and consequently is potentially counter-productive.

Thus, one of the main challenges for online coaching is to make the communication sufficiently personalized to the person/participant that is being coached. Briefly, a higher level of personalization leads to an increased effectiveness of a program for promoting a healthy lifestyle. However, assessing the relevant profile and providing personalized coaching based on this profile for a large number of users increases the workload of a coach. As an effect, the coach does not have adequate time to develop a sufficient level of personalization for each user and still coach a large number of users. Consequently, the cost-effectiveness of the coaching solution is affected.

It is therefore desirable to implement a system for promoting a healthier lifestyle of a subject, the system providing a coaching experience to the subject that is dynamic and responsive to current customer responses, behavior, and psychological aspects. It is further desirable to implement a system considering the objective behavior of the subject, such as a target that a subject desires to reach. It is also desirable to implement such a system that is cost-efficient while maintaining a personalized touch. It is also desirable to provide a method for promoting a healthier lifestyle of a subject, wherein the coaching considers the objective behavior of the subject, and wherein the coaching experience is dynamic and responsive to current consumer responses, behavior and psychological aspects.

### BRIEF DESCRIPTION OF THE FIGURES

The aspects of the present disclosure may be better understood with reference to the following figures. The components in the figures are not necessarily to scale, emphasis instead being placed upon clearly illustrating the principles of the disclosure. Moreover, in the figures, like reference numerals designate corresponding parts throughout the several views.

In the figures:

FIG. 1 shows a schematic representation of components of the system of the invention and illustrates the cooperation of these components in accordance with an embodiment of the present disclosure;

FIG. 2 shows a schematic representation of components of a fact database in accordance with an embodiment of the present disclosure;

FIG. 3 shows a flow chart of a method for suggesting personalized coaching messages;

FIG. 4 shows a flow chart of a method for updating a user profile and suggesting personalized coaching messages in response to a user message or activity; and

FIG. 5 shows a flow chart of a method for updating a user profile and suggesting an alternative to a subject.

### DETAILED DESCRIPTION OF EMBODIMENTS

The present disclosure describes various embodiments of systems, devices, and methods for building coaching messages for physical activity promotion and promoting a healthy lifestyle to a subject.

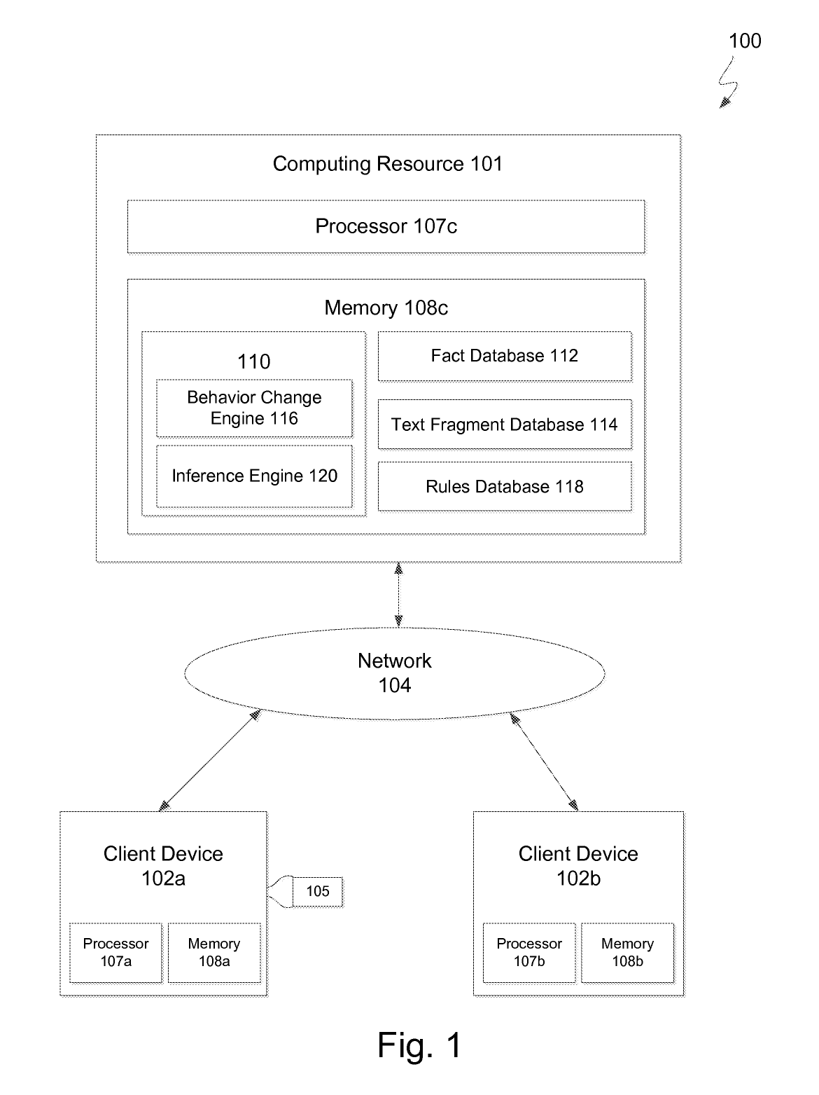

With reference to FIG. 1, shown is a system 100 according to various embodiments. The system 100 includes a computing resource 101, client devices 102a, 102b, and a network 104. The computing resource 101 includes a processor 107c and a memory 108c that stores an application 110. The computing resource 101 may be a server, computer, or another device providing computing capability. In some embodiments, the computing resource 101 includes a plurality of computing resources that are arranged, for example, in one or more server banks, computer banks or other arrangements. Further, in some embodiments, the computing resource 101 includes a cloud computing resource, a grid computing resource, or any other distributed computing arrangement. For purposes of convenience, a computing resource is referred to herein in the singular, but it is understood that a plurality of computing resources may be employed in the various arrangements described above instead. Although application 110 is shown and described herein as being a component of computing resource 101, it is also envisioned that application 110 may be a component of either or both of client devices 102a and 102b.

A client device 102 (e.g., denoted as client devices 102a, 102b) is representative of a plurality of client devices that may be coupled to the network 104. In the embodiment illustrated in FIG. 1, the client device 102a is associated with a subject (i.e., a user, client, coachee). The client device 102a may be configured to communicate with an activity monitor 105, which will be discussed in further detail below. Additionally, or alternatively, the activity monitor 105 may be configured to communicate with the computing resource 101 over the network 104 without a client device 102 as an intermediary. The client device 102b is associated with a coach. Client devices 102 may be configured to receive data from activity monitor 105, or otherwise transmit data between activity monitor 105, client devices 102, and computing resource 101, as will be described in further detail below. Although activity monitor 105 is shown and described as being a separate component, unit, or element, from client device 102, it is also envisioned that client device 102, in particular client device 102a, may be configured to perform all of the functions of activity monitor 105.

A client device 102 may include, for example, a processor-based system such as a computer system. Such a computer system may be embodied in the form of a desktop computer, a laptop computer, a personal digital assistant, a mobile device, a cellular telephone, a smart phone, a set-top box, a music player, a web pad, a tablet computer system, a gaming console, or other devices with like capability. The client device 102 may be configured to execute various applications such as a browser and/or other applications. When executed in a client device 102, the browser may render network pages, such as web pages, on a display device and may perform other functions. The browser may be executed in a client device 102 for example, to access, render, or display network pages, such as web pages, or other network content served up by the computing resource 101 and/or other servers. The client device 102 may be configured to execute applications other than a browser such as, for example, email applications, instant message applications, mobile applications, and/or other applications.

The network 104 includes, for example, the Internet, intranets, extranets, wired networks, wireless networks, wide area networks (WANs), local area networks (LANs), or other suitable networks, etc., or any combination of two or more such networks.

The computing resource 101 and client devices 102 each respectively include a processor 107 and a memory 108. In the embodiment illustrated in FIG. 1, the client device 102a includes a processor 107a and a memory 108a, and the client device 102b includes a processor 107b and a memory 108b. Further, the computing resource 101 includes a processor 107c and a memory 108c. In some embodiments, the computing resource 101 and client device 102 may include more than one processor 107 and more than one memory 108. For purposes of convenience, the processor 107 and memory 108 are referred to herein in the singular, but it is understood that a plurality of processors 107 and/or a plurality of memories 108 may be employed by a computing resource 101 or a client device 102.

Processor 107 is configured to process any of the steps or functions of computing resource 101 and/or system 100, and/or any of the modules, units, or components thereof. The term processor, as used herein, may be any type of controller or processor, and may be embodied as one or more controllers or processors adapted to perform the functionality discussed herein. Additionally, as the term processor is used herein, a processor may include use of a single integrated circuit (IC), or may include use of a plurality of integrated circuits or other components connected, arranged or grouped together, such as controllers, microprocessors, digital signal processors, parallel processors, multiple core processors, custom ICs, application specific integrated circuits, field programmable gate arrays, adaptive computing ICs, associated memory, such as and without limitation, RAM, DRAM and ROM, and other ICs and components.

A memory 108 may include both volatile and/or nonvolatile memory and data storage components. Volatile components are those that do not retain data values upon loss of power. Nonvolatile components are those that retain data upon a loss of power. Thus, the memory may include, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may include, for example, static random access memory (SRAM), dynamic random access memory (DRAM), or magnetic random access memory (MRAM) and other such devices. The ROM may include, for example, a programmable read-only memory (PROM), an erasable programmable read-only memory (EPROM), an electrically erasable programmable read-only memory (EEPROM), another like memory device. A memory 108 is a computer readable medium.

Further, a memory 108 may store instructions that are executable by the processor 107. For example, the memory 108c of the computing resource 101 stores instructions for the application 110 for promoting a healthier lifestyle of a subject. The term subject designates the user associated with client device 102a, and this user is the coachee (i.e., the person who is coached by the system 100 and/or the coach). This person may also be designated as customer, client, and/or subject in the present text. The memory 108c may also include a fact database 112 that includes a plurality of user profiles 112p, as will be described in further detail below. Each user profile 112p may be associated with a particular subject. The memory 108c further includes a text fragment database 114 that may include a collection of standardized text fragments. Each of the text fragments may be a potential personalized message for selection by computing resource 101 and/or any components thereof.

The application 110 for promoting a healthier lifestyle of a subject includes instructions that, when executed by the processor 107c, cause the computing resource 101, via any of the components thereof, to generate at least one personalized message for the subject upon being triggered, as will be described in further detail below. The at least one personalized message is generated based at least in part on the standardized text fragments in the text fragment database 114 and the user profile 112p associated with the particular subject stored in the fact database 112. The at least one personalized message may be communicated to the client device 102b for review by the human coach. The client device 102b may be used by the human coach to send the at least one personalized message either automatically or manually upon confirmation, selection and/or amendment.

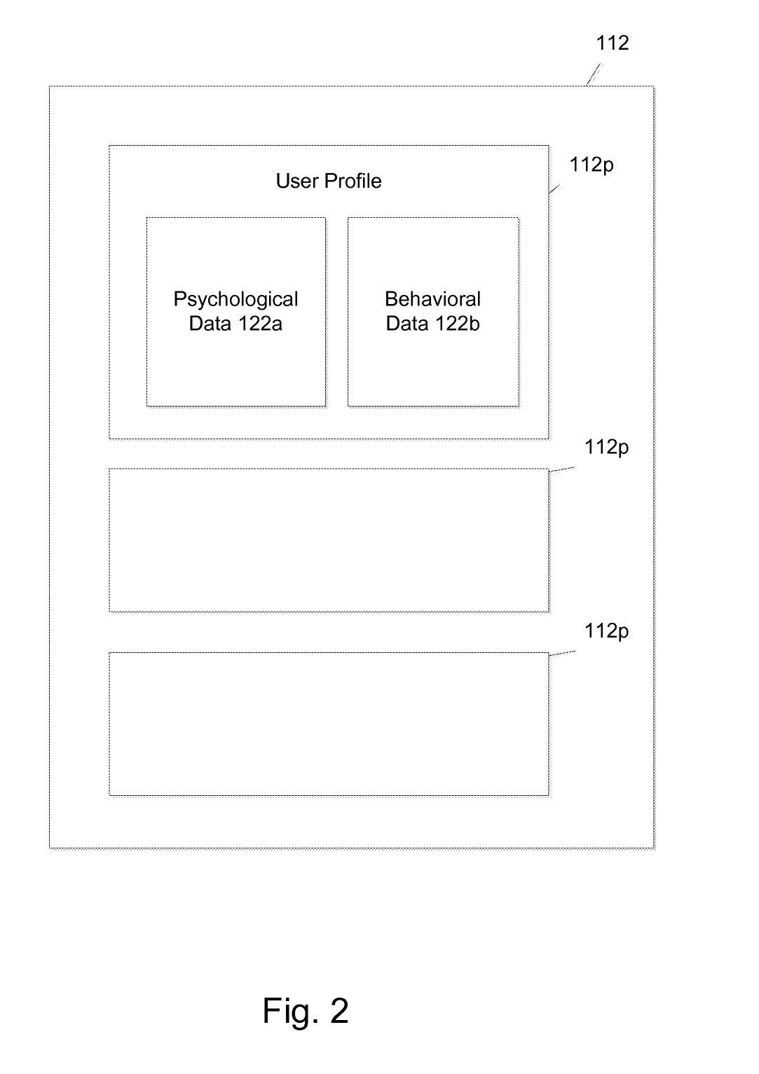

The application 110 for promoting a healthier lifestyle of a subject may include a behavior change engine (BCE) 116, also designated as coaching engine. The BCE 116 includes instructions that, when executed by the processor 107c, cause the computing resource 101 to gather data regarding a particular subject and support a human coach by proposing personalized messages for the particular subject based on the user profile 112p of the particular subject stored in the fact database 112, and data stored therein. In particular, the proposed messages may be constructed based at least in part on the user profile 112p associated with the subject. The user profile 112p, in the fact database 112, may include psychological data 122a and/or behavioral data 122b regarding the subject, as will be described in further detail below with reference to FIG. 2. The psychological data 122a may include motivational, personality, and attitudinal aspects. The behavioral data 122b may include data corresponding to activity behavior aspects and optionally includes data related to interaction with the system such as—for example—the login behavior of the subject and subject's reactions to delivered messages.

The BCE 116 may be configured to build and update the user profile 112p associated with a particular subject in the fact database 112 at the beginning of the coaching journey. In addition, the user profile 112p may be updated in the fact database 112 during the coaching journey by the BCE 116, even if the subject does not respond to one or more messages that are sent to the client device 102a, which is associated with him/her. Moreover, the user profile 112p may be updated even after a coaching journey is completed such that an updated user profile 112p may be used if the subject subsequently to an already completed coaching journey wants to begin with another coaching journey. The subject's user profile 112p is preferably built on data corresponding to measured behavioral patterns and/or the responses of the subject to a set of questions. In an embodiment, the BCE 116 may be configured to maintain and amend the user profile 112p associated with a subject during the coaching journey. The user profile 112p associated with a subject in the fact database 112 may determine the content, timing and preferred delivery method, e.g. e-mail, SMS, instant message, phone/voice call, and/or push notifications on a client device, such as a mobile phone, for each message to be sent to the subject.

The messages to be sent to the subject may be proposed by the BCE 116 and sent to client device 102b which is associated with a human coach. The messages may be composed from standardized text fragments, and may also be tailored to the writing style of the particular human coach prior to, or subsequent to, delivery to the coach, as will be described in further detail below. The messages may be further tailored by the human coach, reviewed, amended, and/or forward to the client device 102a associated with the particular subject.

In particular, the BCE 116 may be configured to detect behavior and/or activity of a particular subject, review the user profile 112p associated with the particular subject (and the data stored therein), search a collection of text fragments which include a plurality of potential personalized messages, select at least one of the personalized messages, and send the selected personalized messages to the client device 102b associated with the coach, as will be described in further detail below.

Turning now to FIG. 2, as mentioned above, the memory 108c may include a fact database 112 that may store one or a plurality of user profiles 112p. Each user profile 112p is associated with a particular subject. The user profile 112p may include psychological data 122a and/or behavioral data 122b of the particular subject. The psychological data 122a may include data corresponding to motivational aspects, personality and/or attitudinal aspects. The behavioral data 122b may include data corresponding to activity behavior aspects and optionally includes data related to interaction with the system 100, for example, the login behavior of the subject when the subject uses the system 100 as an Internet based system, i.e. where for example the user utilizes the Internet to send messages from a client device 102a to the computing resource 101 and/or to upload behavioral data 122b or activity data. Each user profile 112p may be amended during the coaching journey, or otherwise updated. Events which trigger the amending of the user profile 112p associated with a subject may include, for example and without limitation, selected from the group consisting of pattern classification, upload of behavior data, assessments of questionnaires throughout the coaching journey, responses to messages such as time and content of in-coming e-mail messages and persuasive effect of messages sent to the subject, detected activity highlights and the like, and any other manual or automatic amendment that may be appreciated in the art.

The fact database 112 may be updated by machine learning algorithms stored as instructions in the memory 108c and/or in response to answers to questionnaires by either or both of the subject and the coach. Alternatively or in addition, the fact database 112 may be updated by the human coach or human coaches. Hence, human coaches can review and update the facts, including the psychological data 122a and/or behavioral data 122b associated with user profiles 122p, in the fact database 112. Optionally, a non-limiting set of profiling mechanisms may be used to create a personalized coaching journey. Within the personalized coaching journey, the data corresponding to the activity and/or behavior of the subject may be measured, preferably via activity monitors and/or by manual responses of the subject. These data may be interpreted with respect to activity patterns which are significantly distinct from each other such as, for example, inactive, more inactive than active, more active than inactive, or active and may be stored in the fact database 112. Subsequently, the data corresponding to these activity patterns warrant different types of coaching strategies as represented for example by different types of personalized messages.

Referring back to FIG. 1, the memory 108c may include a text fragment database 114. The text fragment database 114 includes text fragments for potential personalized messages to be sent to the client device 102 associated with the subject and/or coach. Additionally, or alternatively, the text fragments and/or personalized messages may be sent to the client device 102b associated with the coach for review, amendment, or forwarding to the client device 102a associated with the subject. The text fragments are used by the computing resource 101 to generate messages that are proposed to the human coach. The messages that are generated by the system 100 may be messages appealing to the subject's sense of commitment and consistency. Other messages may refer to authority arguments, consensus arguments, or other social influence strategies. Still other messages may simply be supportive. The messages may be adapted to the human coach's style and vocabulary, i.e. the at least one personalized message is based at least in part on the style and/or vocabulary of the human coach. The messages may be proposed, or otherwise delivered, to client device 102b associated with the human coach and may either be ignored, amended before being sent to the client device 102 associated with the subject, or sent to the client device 102a associated with the subject without amendment.

The BCE 116 may further be configured to adapt to the subject's reception of the messages delivered to the subject, or otherwise learn the subject's responses, and/or reaction, to the personalized messages delivered. For example and without limitation, in a non-limiting embodiment, the type of messages that are to be sent to the subject may change during the coaching journey based on the subject's response/reaction to the message, or other factors. For example and without limitation, at the beginning of a coaching journey more preparatory messages may be sent to the subject, wherein later personalized messages towards the closure of a phase of the coaching journey, and preparation of a subsequent phase of the coaching journey may be sent to the user. Additionally, or alternatively, data corresponding to the subject's reaction to the message may be stored in the fact database 112 for future use, as will be described in further detail below.

Continuing with reference to FIG. 1, and according to a non-limiting embodiment, the memory 108c may further include a rules database 118 including inference rules, and/or an inference engine 120 including inference evaluation instructions for evaluating inference rules in the rules database 118. Additionally, or alternatively, the BCE 116 may be configured to evaluate the inference rules in the inference database 118.

In an embodiment, the inference rules are pairs of condition and action. The condition part defines which facts from the fact database 112 must hold for an action to be executed. For example and without limitation, two types of action may include: (i) actions that propose a message type such as—for example—an introductory message, and (ii) actions that actually construct a message from standardized text fragments stored in the text database 114. In an embodiment, the inference rules in the rules database 118 may be generated manually and represent a model of the coaching journey. In a different embodiment, the inference rules may be created automatically. Using a large collection of user profiles 112p in the fact database 112, or the particular user profile 112p associated with the particular subject, messages sent to subjects by human coaches that were stored in the fact database 112, and data corresponding to responses/reactions, or other psychological and/or behavioral data stored in the fact database 112, actions (i.e. messages) may be derived for a particular user.

The inference rules in the rules database 118 may be evaluated by an inference engine 120 and/or the BCE 116 included in the memory 108c of the computing resource 101. The inference engine 120 may be triggered at a fixed time interval or as a result of a user action (for example uploading activity data, or a user logging into the system 100) to propose the at least one personalized message to the human coach. The output may be a set of personalized messages selected from the text fragment database 114 that are proposed to the human coach and/or sent immediately to client device 102a associated with the client/subject/coachee.

In an embodiment, the system 100 may be implemented such that the inference engine 120 and/or the BCE 116 may also cause the computing resource 101 to automatically generate messages from the text fragment database 114 and send it to the client device 102 associated with the subject and/or coach. The automatic generation and sending of messages may occur in addition to and supplement the tailored messages sent to the subject by the human coach.

The BCE 116, which is implemented in the computing resource 101, may enable dynamic adaptation of the coaching experience. In some embodiments, the BCE 116 links coaching messages that are sent to the subject to the behavioral response of the subject—e.g. the effectiveness of the coaching can be determined and thus the coaching journey is adapted to ensure effectiveness at the individual level of each subject. The coaching messages and/or data corresponding to the behavioral response of the subject may be stored in the fact database 112. With data corresponding to the behavioral response, and/or reaction, of the subject stored in the fact database 112, the BCE 116 and/or the inference engine 120 may utilize the stored data in future configurations both for the same subject and for other subjects with similar, or otherwise overlapping, characteristics.

To detect the activity pattern of subjects, the computing resource 101 may distinguish between data corresponding to activity patterns via the BCE 116 and/or other component. A machine learning algorithm may be trained on a set of classifications provided by human coaches. This algorithm may use activity data, preferably from a single activity monitor 105 or multiple simultaneously usable activity monitors 105, which for example may measure acceleration such as an accelerator or gyroscope, to classify the behavior of the subject into an activity pattern. The algorithm may use data corresponding to daily physical activity level (PAL) scores, hourly calories, daily consecutive minutes of moderately intense activity and daily consecutive minutes of highly intense activity as input. The output is preferably a classification into activity patterns which may be stored as data in the fact database 112. Similar to the behavioral data, with the data corresponding to activity patterns stored in the fact database 112, the BCE 116 and/or inference engine 120 may be better suited to select a more appropriate text fragment from the text database 114, when proposing future messages for both the same subject and other subjects possessing similar, or otherwise overlapping, characteristics.

The pattern classification algorithm may update the fact database 112 accordingly via the BCE 116 and/or the inference engine 120. Activity profiles may be updated at various stages during the coaching journey. Thus, a dynamic coaching experience may result from a combination of hybrid coaching with machine suggested messages influenced by behavioral input data.

To create a psychological profile and to maintain the data corresponding to the psychological profile of the subjects, the system 100 may occasionally propose a questionnaire related to the psychological constructs and mechanisms that are known to play a key role for health behavior change. Answers to the questionnaire may be automatically processed and used to build a psychological profile of the subject. The questionnaire for example may determine self-efficacy of the subject. In addition to the self-efficacy questionnaire, the system 100 may further propose questionnaires on the following psychological constructs: stage-of-change, locus of control, personality, need for cognition, persuadability, motivation, motives, social-individual focus, and barriers. Moreover, questionnaires can be included regarding demographics and descriptions of interests and daily activities such as hobbies, occupation etc.

For subjects who respond to these questionnaires, a more elaborate user profile 112p may be built and the fact database 112 may be updated accordingly via the BCE 116 and/or the inference engine 120. As a result of this dynamic adaptation of the fact database 112, the coaching journey of a subject in the program may be personalized and unique, in terms of coaching frequency and content of the coaching messages.

Next to the activity profile and to the psychological profile, coaching messages (both hybrid, where the coaching message are sent to the coach for further editing/approval before being delivered to the subject, and automatic, where coaching messages are delivered directly to the subject) are generated according to a personalized influence strategy via the BCE 116 and/or the inference engine 120. For example: some coaching messages appeal to the data corresponding to the subject's sense of commitment and consistency (e.g. goals that are set earlier in the program), while other messages refer to authority arguments such as “general practitioners recommend at least 30 minutes of daily exercise”. The system 100 enables matching of behavioral data 122b with data corresponding to the subject's responsiveness to specific persuasive messages to determine a susceptibility to one or more influence strategies. The combination of the behavioral profile and the determinants of the influencing strategy effectiveness further determine the coaching experience and ensure usage of arguments that are effective for the specific subject. The system 100 may also generate activity data upload reminder messages, i.e. messages that remind the subject to upload activity data, to see what influencing strategy is most effective and to build a persuasion profile.

In another or additional embodiment, the system 100 may further include an activity monitor 105 for continuously monitoring the activity of the subject. The activity monitor 105 may be a sensor for detecting certain behavior of the subject. The activity monitor 105 continuously monitors the activity of the subject and may be implemented to automatically amend the user profile 112p of the subject when the subject logs into the system or other activity is detected. Examples of such sensors are accelerometers and global positioning systems (GPS). The sensors may be adapted to detect elevator usage and means of transportation such as car, bus or train. The activity monitor 105 permits recording of the objective behavior and objective activity of the subject.

The BCE 116 may further be configured to compute alternatives for the subject, as will be described in further detail below. By detecting the behavior of the subject, alternatives may be computed, i.e. more active means of transportation. For the car/train usage, other forms of transportation that require more physical activity may be presented to the subject. With respect to the elevator, the energy expenditure when taking the stairs may be estimated. By presenting these alternatives to the user, awareness is created in “missed calories” and actionable advice is given on how to easily improve the activity level within the current lifestyle. Such an extension of the system 100 creates insights into missed calories, or missed opportunities, and presents actionable advice to the user on how to increase physical activity.

Additionally, or alternatively, the system 100 may provide insights into physical activity opportunities by taking an approach comparable to the highlight detection algorithm. When data corresponding to the activity levels at a certain moment in time (e.g. Monday morning at 08:00) show fluctuations over a period of time, such moments indicated as a decision moments to be active or not. The system 100 may then present the client device 102 associated with the user and/or coach with messages right before such decision moments. At these moments in time, the option to be active or not (e.g. bike vs. car) may still be open.

In an embodiment of the system 100, the user is invited to contact the coach via a textual message such as an e-mail, text message, mail, social networking site, or any other communication means appreciated in the art. Upon receiving the incoming message from the user, the BCE 116 will analyze the incoming message to support the coach and to further profile the user, as will be discussed in further detail below.

Using machine learning algorithms, the BCE 116 and/or the inference engine 120 may classify the incoming messages based on the topic. The system 100 may include a collection of messages that are annotated with their topic such as “injury” or “activity advice”. The BCE 116 and/or the inference engine 120 may be configured to compare the collection with the incoming, or otherwise received, message, for example utilizing a k-nearest neighbors algorithm. It is envisioned, however, that any other machine learning algorithm which computes a classification for the incoming text may be used. The BCE 116 and/or the inference engine 120 may use the algorithm to detect which messages in the annotated collection resemble the received message best. Using the annotations in the collection, the topic of the received message is determined. It is envisioned that the message and the topic which has been determined may be stored in the fact database 112 for future comparisons and for use with other users.

Having determined one or multiple topics for an incoming message, the BCE 116 and/or inference engine 120 may then identify elements for the reply of the received message. The BCE 116 and/or inference engine 120 may use a look-up table to link the topics to message fragments, i.e. text fragments in the text fragment database 114, that are offered to the coach to be included into the reply. A topic may be linked to multiple text fragments that have been given a priority. The BCE 116 and/or inference engine 120 may search for previously used messages to ensure that a previously used message is not used again for this particular user and thus may assist in preventing the coach from sending the same fragment twice to the same subject. The BCE 116 and/or inference engine 120 may select the fragment with the highest priority score from the text fragment database 114 and send the text fragment to the coach for review, forwarding to the client, amendment and/or directly to the subject, i.e., the user.

To facilitate the automatic profiling of the user, the BCE 116 may also use the received message to profile the user, and store such data in the fact database 112. To do so, a vocabulary of terms may be created that are relevant for the program. This vocabulary may consist of terms that profile the user's daily activities, such as hobbies, employers, occupation, family situation, etc. To improve the recall of the algorithm, each of the terms in the vocabulary may be accompanied by one or more synonyms.

As no 100% accuracy for natural language processing algorithms can be expected, all extracted terms may be linked with the fragment they are extracted from. The coach may then review and adjust the list of topics using the context of the original message.

Methods implemented via system 100 will now be described with particular detail and with reference to FIGS. 1-5. Although the methods described and illustrated herein are shown as being completed via particular steps and in a specific order, it is envisioned that any of the methods may be completed by only some of the steps and not particularly in the order described. Additionally, although the methods described and illustrated herein are described as being carried out by particular components of system 100, it is envisioned that any of the components, i.e. BCE 116, application 110, inference engine 120, processor 107c, memory 108c, computing resource 101, client devices 102, may be configured to carry out some or all of the steps described herein.

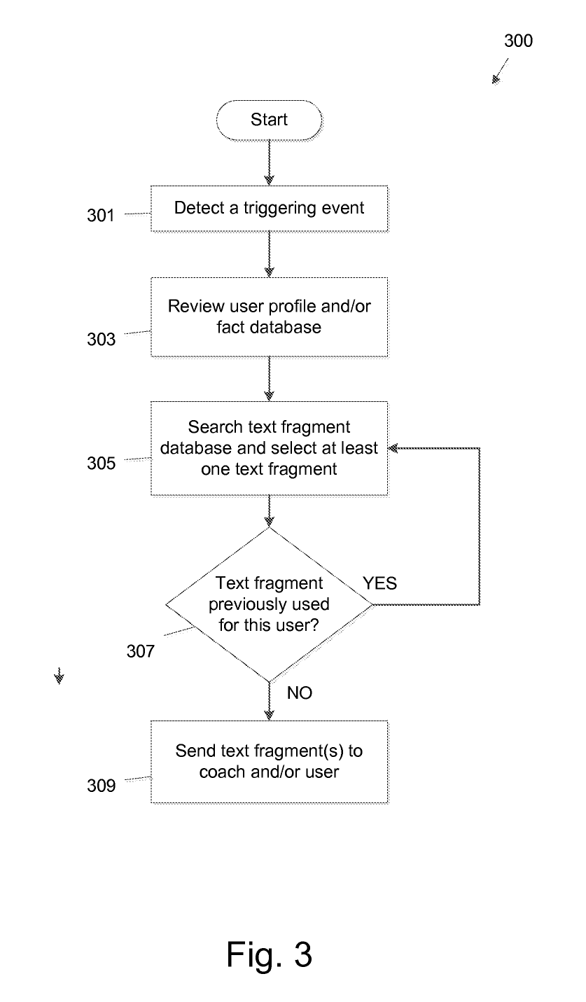

Turning now to FIG. 3, a method for suggesting personalized coaching messages for a particular subject is shown as method 300. Method 300 begins with step 301 by detecting a triggering event. A triggering event may be based on data corresponding to objective behavior, current behavior, or activity of the subject. As described above, a triggering event may include a lapse of a predetermined period of time. For example, and without limitation, a triggering event may be a specific time every day. It is envisioned that triggering events may vary between different subjects. Subsequent to detecting a triggering event in step 301, method 300 proceeds to step 303.

In step 303, method 300 reviews the user profile 112p associated with the subject and/or the fact database 112. In particular, in step 303 the BCE 116 and/or inference engine 120 may review the psychological constructs 122a and behavior data 122b of the subject present in the fact database 112. The user profile 112p may include data corresponding to the particular user's responsiveness to different types of messages, i.e. text fragments that may be selected. For example and without limitation, the user may be more receptive, or otherwise suggestible, by messages that include authoritative arguments. Additionally, or alternatively, the user's profile 112p may include data that indicates that the user may be more receptive to messages including positive reinforcement. The BCE 116 and/or inference engine 120 use this information included in the user profile 112p when selecting the most appropriate text in the steps that follow. Subsequent to reviewing the user profile 112p or user profiles 112p in the fact database 112 in step 303, method 300 then proceeds to step 305.

In step 305, the method 300 proceeds to search the text fragment database 114 and select at least on text fragment. In particular, the BCE 116 and/or inference engine 120 searches the text fragment database 114 and selects at least one of the text fragments best suited based on the conditions and actions set forth in the rules database 118. As described above, the test fragment database 114 may include a collection of text fragments which may include a plurality of potential personalized messages to send to the client device 102 associated with the subject and/or coach. The BCE 116 and/or inference engine 120, in step 305, searches through the collection of text fragments and selects at least one of the text fragments to be used as a potential personalized message based in part on at least the user profile 112p of the particular subject, and the data stored therein.

Subsequent to completing step 305, method 300 then proceeds to step 307 where it is determined whether any of the text fragments selected in step 305 were previously used for this particular subject. In particular, the BCE 116 and/or inference engine 120 searches the fact database 112 to determine if the text fragments were previously selected and already either sent to the coach or the subject. If it is determined that the text fragment was already used for this particular subject (YES in step 307), then the method 300 reverts back to step 305 to search and select a new text fragment to replace the one that has already been used. Alternatively, if it is determined that the text fragment has never been used for this particular subject (NO in step 307), then method 300 proceeds to step 309.

In step 309, the text fragments (which may also be referred to herein as potential personalized messages) selected in step 305 are sent to client device 102b associated with a coach. As previously described, the coach may forward the message to the client device 102a associated with the subject, may review the message, and/or may amend the message. Additionally, or alternatively, step 309 may also include sending the potential personalized message to the client device 102a associated with the subject directly.

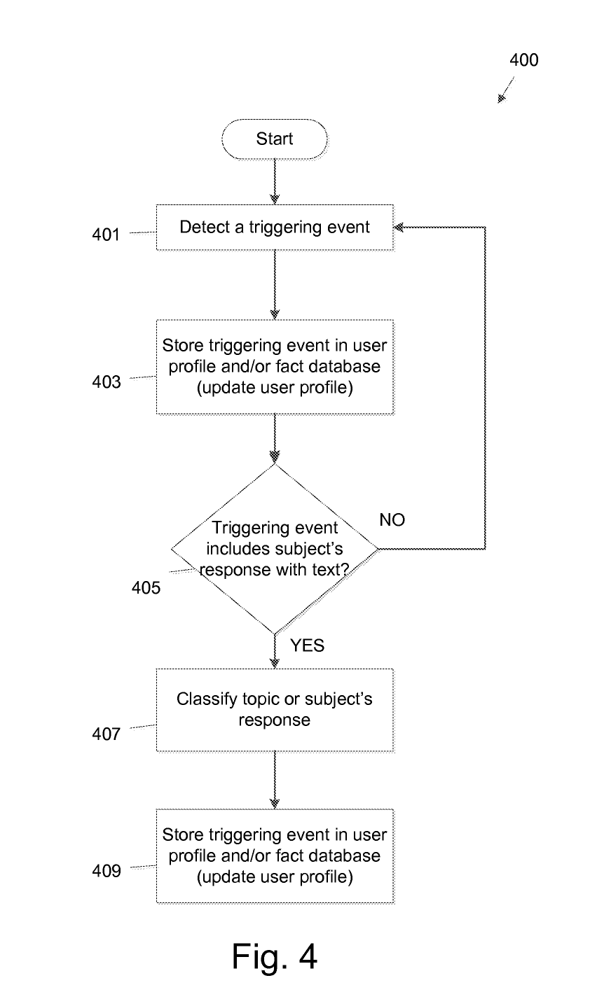

Turning now to FIG. 4, a method for updating a user profile based on user behavior will now be described as shown as method 400. Method 400 begins at step 401 by detecting a triggering event. A triggering event, with respect to step 401, may include without limitation data corresponding to a subject's response to receiving a message from a coach, the subject's behavior, the subject's activity, and combinations thereof, and/or any other events described above. Subsequent to detecting a triggering event in step 401, method 400 proceeds to step 403.

In step 403, method 400 stores the triggering event in the fact database 112, and preferably in the user profile 112p of the particular user. In particular, BCE 116 and/or inference engine 120 may store the data corresponding to the response, activity and/or behavior. For example and without limitation, when the triggering event detected in step 401 includes a subject's response which includes text, the text is stored in the fact database 112 for future use and to assist in developing the rules database 118. Subsequent to completing step 403, method then proceeds to step 405.

In step 405, it is determined whether the triggering event includes text in the subject's response. If the subject's response does not include text (NO in step 403), then method 400 may revert back to step 401 to wait for another triggering event. Alternatively, if the subject's response does include text (YES in step 405), then method proceeds to step 407.

In step 407, method 400 classifies the topic of the subject's response. In particular, as described above, BCE 116 and/or inference engine 120 may classify the incoming message based on the topic, such as and without limitation “injury” or “activity advice.” Subsequent to classifying the topic of the subject's response in step 407, method 400 proceeds to step 409.

In step 409, method 400 compares the subject's message, which may be by topic, with other messages that have been recorded in the fact database 112. In particular, BCE 116 and/or inference engine 120 may use an algorithm to detect which messages in the fact database 112 resemble the subject's best. Subsequent to completing step 409, method 400 proceeds to step 411.

In step 411, method 400 suggests a personalized message for the coach. In particular, step 411 includes similar steps to those present in method 300 and therefore will not be described herein for the sake of brevity.

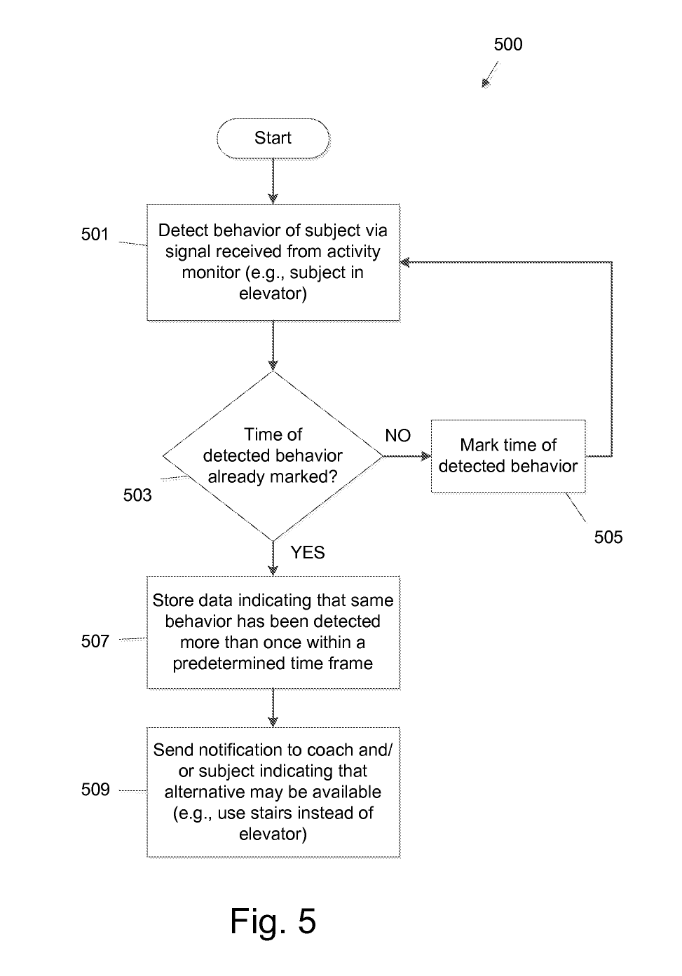

Turning now to FIG. 5, a method for offering a subject an alternative will now be described and shown as method 500. Method 500 begins at step 501 by receiving a signal, or combination of signals, from activity monitor 105, indicating that the subject is undergoing a particular activity and/or behavior. The activity may range from a variety of activities, for example and without limitation, using an elevator or escalator, riding in a vehicle or the like. Subsequent to receiving the signal at step 501, the method 500 then turns to determine whether the time and/or location of the detected behavior has already been marked or otherwise stored in the fact database 112 at step 503 by searching the fact database 112 for similar signals that were received at similar locations/and or times of day.

If the time and/or location information has not already been marked or otherwise stored in the fact database 112 (NO in step 503), then method 500 proceeds to step 505 where data corresponding to the time and/or location of the detected activity is stored in the fact database 112. Subsequent to storing the data corresponding to the time and/or location in the fact database 112, method 500 returns to step 501 where it waits to receive another signal from the activity monitor 105.

Alternatively, if data corresponding to the time and/or location information has been marked, or otherwise stored, in the fact database 112 (YES in step 503), then method 500 proceeds to step 507 where a notification is stored in the fact database 112 indicating that repeat behavior/activity has been detected. In particular, the BCE 116 and/or the inference engine 120 may store data indicating repeat behavior. Subsequent to completing step 507, method 500 proceeds to step 509.

In step 509, method 500 sends a notification to either or both of client device 102 associated with the coach and the subject. The notification may indicate that an alternative may be available. In particular, by detecting the data corresponding to the behavior of the subject, alternatives may be computed, i.e. more active means of transportation. For the car/train usage, other forms of transportation that require more physical activity may be presented to the subject and/or the coach in the notification in step 509. For example and without limitation, with respect to the elevator, the energy expenditure when taking the stairs may be estimated in step 509 and such information may be included in the notification. By presenting these alternatives to the user and/or the coach in step 509, awareness is created in “missed calories” and actionable advice is given on how to easily improve the activity level within the current lifestyle. Such an extension of the system 100 creates insights into missed calories, or missed opportunities, and presents actionable advice to the user on how to increase physical activity.

Additionally, or alternatively, the method 500 may provide insights into physical activity opportunities by taking an approach comparable to the highlight detection algorithm. When the activity levels at a certain moment in time (e.g. Monday morning at 08:00) show fluctuations over a period of time, such moments indicated as a decision moments to be active or not. The system 100 may then present the user with messages right before such decision moments. At these moments in time, the option to be active or not (e.g. bike vs. car) may still be open, and the notification sent in step 509 may indicate such options.

Although, the above-described embodiments have been described as being applicable to coaching and promoting a healthy lifestyle in a subject, it is envisioned that any of the above-described embodiments may be implemented in any system and may be used by any individuals not described above, for any purpose other that those described above.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A method for promoting a healthy lifestyle to a subject, comprising:
detecting, using a computing resource, data corresponding to objective behavior, current behavior, or activity of the subject;
reviewing, using the computing resource, a user profile associated with the subject, wherein the user profile includes at least one modifiable psychological construct and behavior data associated with the subject, wherein the behavior data corresponds to at least one of the object behavior, current behavior, or activity of the subject;
searching, using the computing resource, a text fragment database including a collection of text fragments;
selecting, using the computing resource, at least one of the text fragments based at least in part on at least the user profile of the subject reviewed in the reviewing step;
sending, using the computing resource, at least one of the text fragments selected in the selecting step to a client device associated with a coach for review, amendment, or forwarding to a client device associated with the subject.

2. The method according to claim 1, further comprising updating, using the computing resource, the user profile by storing the data corresponding to the objective behavior, current behavior, or activity of the subject detected in the detecting step.

3. The method according to claim 1, further comprising determining, using the computing resource, whether the selected text fragment has already been used for the subject.

4. The method according to claim 1, further comprising delivering, using the computing resource, a message to the client device associated with the subject based on the at least one text fragment selected.

5. The method according to claim 4, further comprising receiving, using the computing resource, at least one of a response from the client device associated with the subject and an indication that the subject has logged into the client device associated with the subject.

6. The method according to claim 5, wherein the response received from the client device associated with the subject includes a text, and the method further comprises:
categorizing, using the computing resource, the response received from the client device associated with the subject using an analysis of the text, wherein a plurality of category labels are computed for each response received from the client device associated with the subject; and
establishing, using the computing resource, a personalized response message to each response received from the subject, wherein the personalized response message comprises elements that are related to coaching content associated with the category labels.

7. The method according to claim 5, further comprising storing, using the computing resource, the response received in the receiving step in the user profile for future use.

8. The method according to claim 1, further comprising receiving, using the computing resource, updated psychological constructs from the client device associated with the subject and updating the user profile based on the updated psychological constructs received.

9. The method according to claim 1, wherein the selecting step includes estimating, using the computing resource, a likelihood of success for at least one of a plurality of psychological influence strategies based at least in part on at least one response received from the subject, wherein the psychological influence strategies include authority, consensus, scarcity, and commitment, and wherein the estimation is based on at least one of meta-judgment data or actual behavior monitored using sensing technologies.

10. The method according to claim 9, wherein the selecting step is based at least in part on the estimates of the likelihood of success and the certainty of the estimates.

11. The method according to claim 1, further comprising:
receiving, using the computing resource, data, including a geographical location of a mobile device associated with the subject and subject activity corresponding to the geographical location, from the mobile device associated with the subject; and
sending, using the computing resource, the personalized message to the mobile device based on the geographical location of the subject.

12. A system for promoting a healthy lifestyle to a subject, the system comprising:
a processor; and
a memory storing instructions executable by the processor, wherein the instructions when executed by the processor cause the system to:
detect data corresponding to objective behavior, current behavior, or activity of the subject;
review a user profile associated with the subject, wherein the user profile includes at least one modifiable psychological construct and behavior data associated with the subject, wherein the behavior data corresponds to at least one of the objective behavior, current behavior, or activity of the subject;
search a text fragment database including a collection of text fragments;
select at least one of the text fragments based at least in part on at least the user profile of the subject reviewed;
send at least one of the text fragments selected to a client device associate with a coach for review, amendment, or forwarding to a client device associated with the subject.

13. The system according to claim 12, wherein the instructions when executed by the processor further cause the system to update the user profile by storing the data corresponding to the objective behavior, current behavior, or activity of the subject detected.

14. The system according to claim 12, wherein the instructions when executed by the processor further cause the system to determine whether the selected text fragment has already been used for the subject.

15. The system according to claim 12, wherein the instructions when executed by the processor further cause the system to deliver a message to the client device associated with the subject based at least on the at least one text fragment selected.

16. The system according to claim 15, wherein the instructions when executed by the processor further cause the system to receive at least one of a response from the client device associated with the subject and an indication that the subject has logged into the client device associated with the subject.

17. The system according to claim 16, wherein the response received from the client device associated with the subject includes a text, and wherein the instructions when executed by the processor further cause the system to:
categorize the response received from the client device associated with the subject using an analysis of the text, wherein a plurality of category labels are computed for each response received from the client device associated with the subject; and
establish a personalized response message to each response received from the subject, wherein the personalized response message comprises elements that are related to coaching content associated with the category labels.

18. The system according to claim 12, wherein the instructions when executed by the processor further cause the system to receive updated psychological constructs from the client device associated with the subject and update the user profile based on the updated psychological constructs received.

19. The system according to claim 12, wherein the at least one text fragment is selected based at least on a likelihood of success for at least one of a plurality of psychological influence strategies based at least in part on at least one response received from the subject, wherein the psychological influence strategies include authority, consensus, scarcity, and commitment, and wherein the estimation is based on at least one of meta-judgment data or actual behavior monitored using sensing technologies.

20. The system according to claim 12, wherein the instructions when executed by the processor further cause the system to:
receive data, including a geographical location of a mobile device associated with the subject and subject activity corresponding to the geographical location, from the mobile device associated with the subject; and
send the personalized message to the mobile device based on the geographical location of the subject.
